(19) United States
(12) Patent Application Publication
(10) Pub. No.: US 2018/0137402 A1
(43) Pub. Date: May 17, 2018

(54) COGNITIVE COMPUTING MEETING FACILITATOR

(71) Applicant: HALLIBURTON ENERGY SERVICES, INC., Houston, TX (US)

(72) Inventors: Amir BAR, Houston, TX (US); Dale E. JAMISON, Humble, TX (US); Robert L. WILLIAMS, Spring, TX (US)

(73) Assignee: HALLIBURTON ENERGY SERVICES, INC., Houston, TX (US)

(21) Appl. No.: 15/576,156

(22) PCT Filed: Jul. 2, 2015
(86) PCT No.: PCT/US15/39118

§ 371 Date: Nov. 21, 2017

(51) Int. Cl. G06N 3/00; G06N 3/063; G06N 3/04; G06N 3/08

(52) U.S. Cl. CPC G06N 3/006; G06N 3/063; G06F 17/30011; G06N 3/049; G06N 3/08; G06N 3/0472

(57) ABSTRACT

A system for facilitating meetings, in some embodiments, comprises: neurosynaptic processing logic; and one or more information repositories accessible to the neurosynaptic processing logic, wherein, during a meeting of participants that includes the neurosynaptic processing logic, the neurosynaptic processing logic accesses resources from the one or more information repositories to perform a probabilistic analysis, and wherein, based on said probabilistic analysis, the neurosynaptic processing logic answers a question from one or more of the participants, asks a question of the participants, makes a statement to the participants, or provides a suggestion to the participants.

### BACKGROUND

Computer scientists and engineers have long tried to create computers that mimic the mammalian brain. Such efforts have met with limited success. While the brain contains a vast, complex and efficient network of neurons that operate in parallel and communicate with each other via dendrites, axons and synapses, virtually all computers to date employ the traditional von Neumann architecture and thus contain some variation of a basic set of components (e.g., a central processing unit, registers, a memory to store data and instructions, external mass storage, and input/output devices). Due at least in part to this relatively simple architecture, von Neumann computers are adept at performing calculations and following specific, deterministic instructions, but—in contrast to the biological brain—they are generally inefficient; they adapt poorly to new, unfamiliar and probabilistic situations; and they are unable to learn, think, and handle data that is vague, noisy, or otherwise imprecise. These shortcomings substantially limit the traditional von Neumann computer's ability to make meaningful contributions in the oil and gas and other industries.

### BRIEF DESCRIPTION OF THE DRAWINGS

Accordingly, there are disclosed in the drawings and in the following description various embodiments of a cognitive computing meeting facilitator that may be used in numerous applications, including the oil and gas context. In the drawings:

FIG. 1A is an illustration of a pair of biological neurons communicating via a synapse.

FIG. 1B is a mathematical representation of an electronic neuron.

FIG. 1C is a schematic diagram of a neurosynaptic tile for use in a cognitive computer.

FIG. 1D is a schematic diagram of a circuit that embodies an electronic synapse.

FIG. 1E is a schematic diagram of an electronic neuron.

FIG. 1F is a block diagram of an electronic neuron spiking logic.

FIG. 2 is a schematic diagram of a neurosynaptic core for use in a cognitive computer.

FIG. 3 is a schematic diagram of a multi-core neurosynaptic chip for use in a cognitive computer.

FIG. 4 is a detailed schematic diagram of a dual-core neurosynaptic chip for use in a cognitive computer.

FIGS. 5 and 6 are conceptual diagrams of scalable corelets used for programming neurosynaptic processing logic.

FIG. 7 is a block diagram of a cognitive computing system that has access to multiple information repositories.

FIG. 8 is an illustration of an exemplary meeting environment with multiple human participants and a cognitive computing participant.

FIG. 9A is a flow diagram of an illustrative method used to facilitate meetings using cognitive computers.

FIG. 9B is a flow diagram of another illustrative method used to facilitate meetings using cognitive computers.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Disclosed herein are methods and systems for facilitating meetings using cognitive computers. Cognitive computers—also known by numerous similar terms, including artificial neural networks, neuromorphic and synaptronic systems, and, in this disclosure, neurosynaptic systems—are modeled after the mammalian brain. In contrast to traditional von Neumann architectures, neurosynaptic systems include extensive networks of electronic neurons and cores operating in parallel with each other. These electronic neurons function in a manner similar to that in which biological neurons function, and they couple to electronic dendrites, axons and synapses that function like biological dendrites, axons and synapses. By modeling processing logic after the biological brain in this manner, cognitive computers—unlike von Neumann machines—are able to support complex cognitive algorithms that replicate the numerous advantages of the biological brain, such as adaptability to ambiguous, unpredictable and constantly changing situations and settings; the ability to understand context (e.g., meaning, time, location, tasks, goals); and the ability to learn new concepts.

Key among these advantages is the ability to learn, because learning fundamentally drives the cognitive computer's behavior. In the cognitive computer—just as with biological neural networks—learning (e.g., Hebbian learning) occurs due to changes in the electronic neuron and synapses as a result of prior experiences (e.g., a training session with a human user) or new information. These changes, described below, affect the cognitive computer's future behavior. In a simple example, a cognitive computer robot with no prior experience or software instructions with respect to coffee preparation can be introduced to a kitchen, shown what a bag of ground coffee beans looks like, and shown how to use a coffee machine. After the robot is trained, it will be able to locate materials and make the cup of coffee on its own, without human assistance. Alternatively, the cognitive computer robot may simply be asked to make a s cup of coffee without being trained to do so. The computer may access information repositories via a network connection (e.g., the Internet) and learn what a cup is, what ground coffee beans are, what they look like and where they are typically found, and how to use a coffee machine—for example, by means of a YOUTUBE® video. A cognitive computer robot that has learned to make coffee in other settings in the past may engage in a conversation with the user to ask a series of specific questions, such as to inquire about the locations of a mug, ground coffee beans, water, the coffee machine, and whether the user likes sugar and cream with his coffee. If, while preparing the coffee, a wet coffee mug slips from the robot's hand and falls to the floor, the robot may infer that a wet mug is susceptible to slipping and it may grasp a wet mug a different way the next time it brews a cup of coffee.

The marriage between neurosynaptic architecture and cognitive algorithms represents the next step beyond artificial intelligence and can prove especially useful in the oil and gas industry, although the techniques disclosed herein find application in many different contexts and industries. This disclosure describes the use of the cognitive computer's neurosynaptic technology (and associated cognitive algorithms) to intelligently facilitate meetings (e.g., meetings between oil and gas personnel). The cognitive computer is an active participant in the meeting and behaves in a manner similar to the human participants. For instance, the cognitive computer listens to the discussion, views presentations, reads documents, asks questions and provides statements or suggestions. In this way, the cognitive computer is substantially more useful in such meetings than a traditional von Neumann computer. The cognitive computer can be more useful than even humans because it has instant access to a vast array of resources stored in one or more information repositories, such as any and all material accessible via the Internet/World Wide Web; journals, articles, books, white papers, reports and all other such documents; speeches; presentations; video and audio files; and any and all other information that a cognitive computer could potentially access. The cognitive computer adds value to the meeting by drawing on these resources to generate its questions, answers, statements and suggestions. The cognitive computer additionally provides arguments supporting and opposing each of its answers or suggestions and engages in conversations with human meeting participants about its answers, suggestions or any other aspect of the meeting agenda. The cognitive computer performs all of these actions intelligently and with minimal or no human assistance using its neurosynaptic architecture and cognitive algorithms.

In addition to being an active participant in the meeting, the cognitive computer functions in an executive capacity by having access to controls for numerous remotely located machines. For instance, the cognitive computer can access and control or at least communicate with other personal computers (e.g., laptops, notebooks), drilling equipment, logging equipment, safety equipment, and other, similar devices. Further, the cognitive computer performs in a secretarial capacity by memorializing the meeting. The cognitive computer may perform this task by generating minutes and other records of the meeting (including what was said during the meeting and who said it (e.g., using commercially available voice recognition software)); tagging such records with relevant keywords or phrases to facilitate location of the records in the future; and updating the resources to which it has access with any relevant information from the meeting (e.g., the tagged records). The cognitive computer also may send copies of the records to one or more persons or entities, such as the meeting participants. The cognitive computer performs these and other actions automatically, intelligently, intuitively and with minimal or no human assistance using its neurosynaptic architecture and cognitive algorithms.

In some cases, the cognitive computer may manage the meeting, meaning that—in addition to the other duties described above—it sets the agenda, initiates discussions, keeps the meeting focused on the agenda and provides reminders when the discussion strays off topic, and distributes assignments to each participant. The scope of disclosure is not limited to this or any other specific set of tasks or roles within a meeting. On the contrary, the cognitive computer has the ability to perform virtually any task that it has been trained to perform.

In an illustrative application, a cognitive computer may be present during a meeting of humans and/or other cognitive computers and may automatically and intuitively identify the meeting agenda by receiving input from the meeting (e.g., listening to the conversation between participants; viewing presentations using a camera; listening to participants using a microphone), by actively asking questions, by receiving a meeting agenda document, or the like. For instance, during a meeting convened between drilling engineers to discuss placement of a new well, the cognitive computer may collect information (e.g., by listening to the conversation between the engineers and viewing presentation materials displayed on a television screen) and may automatically and without prompting determine, using its cognitive algorithms and prior learning experiences, that a new well is being planned and understand all details pertaining to the potential new well.

As the meeting progresses, the cognitive computer is an active participant, asking questions, answering questions and making statements and suggestions. For example, a human participant may ask the cognitive computer to produce a map of a particular oilfield, and the cognitive computer may oblige by accessing relevant resources and displaying the map on a television screen in the meeting room. When asked for a recommendation on an optimal drilling site for a new well in that oilfield, the cognitive computer accesses any number of resources—such as those that include formation properties, time constraints, personnel constraints and financial constraints—to generate a recommendation. The cognitive computer may also generate arguments supporting and opposing its recommendation, as well as a ranked list of alternative recommendations. The ranking algorithm may have been programmed directly into the computer, or the computer may have been trained to use the algorithm, or some combination thereof. The cognitive computer may have automatically modified its ranking algorithm based on past user recommendation selections and subsequent outcomes so that the recommendation most likely to be selected by the user is ranked highest and is most likely to produce the best outcome for the user.

The computer may also engage in conversations with a meeting participant or other entity (e.g., another cognitive computer) about the recommendations, the arguments pertaining to the recommendations, or any item on the meeting agenda in general. For example, a meeting participant may rebut the cognitive computer's arguments supporting a particular suggestion and, in turn, the cognitive computer may rebut the participant's arguments with facts gleaned from any available resource, having been trained to engage in such fact-based conversations in the past. The computer may, for example, explain that although other wells in the field have historically underperformed, the formations abutting those wells were sub-optimally fractured. Based on the participant's responses, the cognitive computer may learn for future use the types of facts and arguments the participant finds most persuasive.

The foregoing example is merely illustrative. The cognitive computer is able to handle virtually any task that it has been trained to perform, regardless of whether that training is provided by another entity or whether the cognitive computer has accessed resources to help it train itself to at least some extent. Numerous such interactions may occur during the course of a single meeting, and the cognitive computer handles some or all such actions using the computer's probabilistic, cognitive algorithms and prior learning experiences. After the meeting is complete, the cognitive computer updates its resources in accordance with information collected during the meeting, thereby improving the accuracy and reliability of the data in the resources. The cognitive computer also generates a summary (e.g., minutes) of the meeting as well as any other such relevant information, and provides the summary and other relevant information to one or more of the meeting participants—for instance, through e-mail.

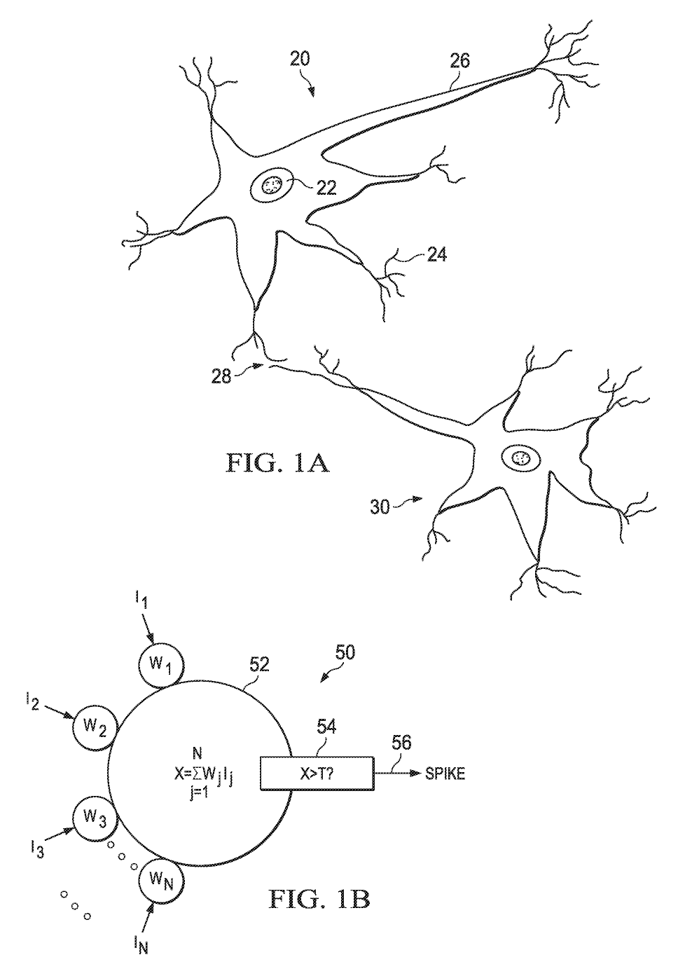

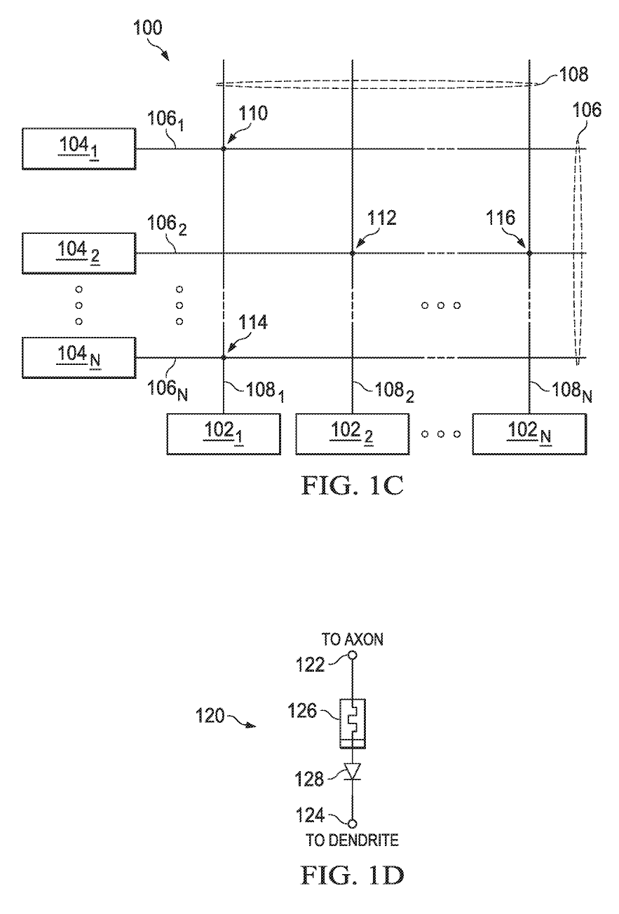

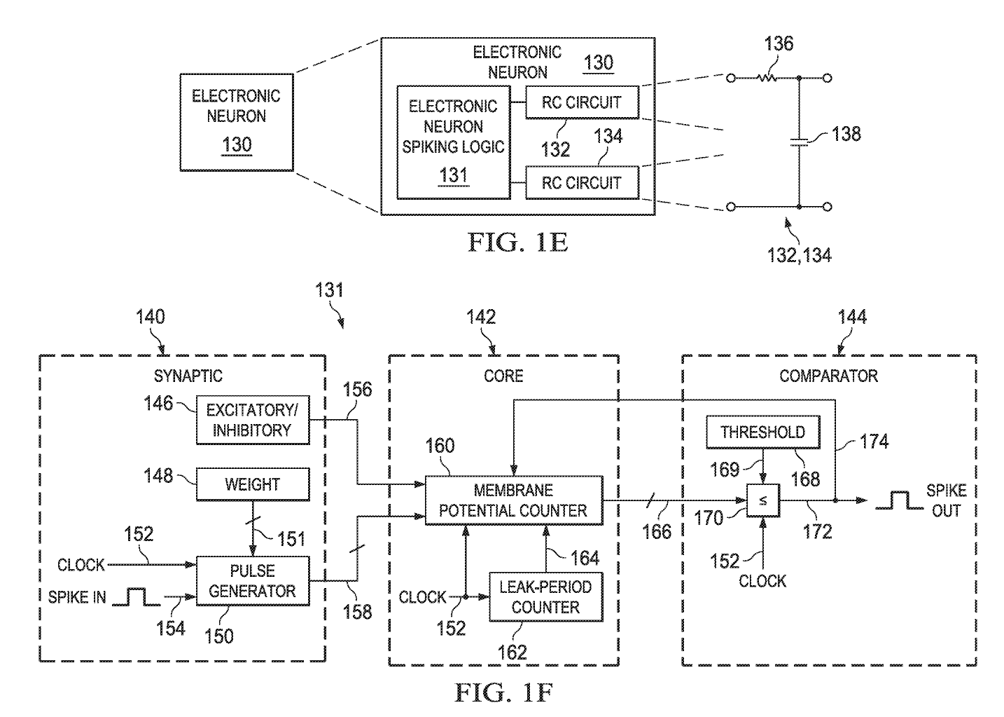

FIG. 1A is an illustration of a pair of biological neurons communicating via a synapse. Specifically, neuron 20 includes a nucleus 22, dendrites 24, an axon 26 and a synapse 28 by which it communicates with another neuron 30. The dendrites 24 serves as inputs to the neuron 20, while the axon 26 serves as an output from the neuron 20. The synapse 28 is the space between an axon of neuron 30 and a dendrite 24 of neuron 20, and it enables the neuron 30 to output information to the neuron 20 using neurotransmitters (e.g., dopamine, norepinephrine). The neuron 20 receives input from numerous neurons (not specifically shown) in addition to the neuron 30. Each of these inputs impacts the neuron 20 in different ways. Some of these neurons provide excitatory signals to the neuron 20, while other neurons provide inhibitory signals to the neuron 20. Excitatory signals push the membrane potential (i.e., the voltage difference between the neuron and the space surrounding the neuron, typically about −70 mV) toward a threshold value which, if exceeded, results in an action potential (or “spiking,” which is the transmission of a pulse) of the neuron 20, and inhibitory signals pull the membrane potential of the neuron 20 away from this threshold. The repeated excitation or inhibition the neuron 20 through these different input pathways results in learning. Stated another way, if a particular input to a neuron repeatedly and persistently causes that neuron to fire, a metabolic change occurs in the synapse associated with that input axon to reduce the resistance in the synapse. This phenomenon is known as the Hebbian learning rule. In a more specific version of Hebbian learning, called spike-timing-dependent plasticity (STDP), repeated presynaptic spike arrival a few milliseconds before postsynaptic action potentials leads to long-term potentiation of that synapse, whereas repeated presynaptic spike arrival a few milliseconds after postsynaptic action potentials leads to long-term depression of the same synapse. STDP is thus a form of neuroplasticity, in which synaptic changes occur due to changes in behavior, environment, neural processes, thinking, and emotions.

FIG. 1B is a mathematical representation of an electronic neuron 50 that mimics the behavior of a biological neuron. Specifically, the electronic neuron 50 includes a nucleus 52 that has multiple inputs I₁, I₂, . . . , I_{N}, and these inputs are associated with weights W₁, W₂, . . . , W_{N}, respectively. The weight associated with an input dictates the impact that that input will have upon the neuron 50 and, more specifically, on the electronic neuron's mathematical equivalent of a biological membrane potential (which, for purposes of this discussion, will still be referred to as a membrane potential). The summation of the weighted inputs produces a membrane potential x, which causes a spike 56 if the potential x exceeds a threshold value T (numeral 54). Similar to Hebbian learning, repeated and persistent signals from a particular input to the electronic neuron 50 that causes the neuron to spike results in a shift in the magnitudes of weights W₁, W₂, . . . , W_{N} to increase the weight associated with that particular input.

FIG. 1C is a schematic diagram of a neurosynaptic tile 100 for use in a cognitive computer. The neurosynaptic tile 100 includes a plurality of electronic neurons 1021, 1022, . . . , 102_{N}. The tile 100 further includes a plurality of electronic neurons 104₁, 104₂, . . . , 104_{N}. Each of the neurons 104₁, 104₂, . . . , 104_{N} couples to an axon 106₁, 106₂, . . . , 106_{N} (generally indicated by numeral 106), respectively. Similarly, each of the neurons 102₁, 102₂, . . . , 102_{N} couples to a dendrite 108₁, 108₂, . . . , 108_{N} (generally indicated by numeral 108), respectively. The axons 106 and dendrites 108 couple to each other in predetermined locations. For example, axon 106₁ couples to dendrite 108₁ at an electronic synapse 110; axon 106₂ couples to dendrites 108₂, 108_{N} at synapses 112, 116, respectively; and axon 106_{N} couples to dendrite 108₁ at synapse 114. In operation, when any of the membrane potentials of the electronic neurons 104₁, 104₂, . . . , 104_{N} reaches or exceeds a threshold value, that neuron(s) fires on the corresponding axon(s) 106. The dendrites 108 to which the firing axons 106 couple receive the spikes and provide them to the neurons 102₁, 102₂, . . . , 102_{N}.

As explained above with respect to FIG. 1B, an electronic neuron may ascribe different weights to each input provided to that neuron. The same is true for the electronic neurons 102₁, 102₂, . . . , 102_{N} and 104₁, 104₂, . . . , 104_{N}. Thus, for example, the dendrite 108₁, which corresponds to electronic neuron 102₁, couples to axons 106₁, 106_{N} at synapses 110, 114, respectively, and the electronic neuron 102₁ ascribes different weights to the inputs from dendrites 106₁ and 106_{N}. If a greater weight is ascribed to dendrite 106₁, the excitatory or inhibitory signal provided by that dendrite receives greater consideration toward the calculation of the membrane potential of the neuron 102₁. Similarly, if a greater weight is ascribed to dendrite 106_{N}, the excitatory or inhibitory signal provided by that dendrite receives greater consideration toward the calculation of the membrane potential of the neuron 102₁. If the summation of the weighted signals received from the dendrites 106₁ and 106_{N} exceeds the threshold of the neuron 102₁, the neuron 102₁ spikes on its axon (not specifically shown). In this way-by strengthening some electronic synapses and weakening others through the adjustment of input weights-these neurons implement an electronic version of STDP.

FIG. 1D is a schematic diagram of a circuit that embodies an electronic synapse, such as the electronic synapses 110, 112, 114, 116 shown in FIG. 1C. Specifically, the electronic synapse 120 in FIG. 1D includes a node 122 that couples to an axon, a node 124 that couples to a dendrite, and a memristor 126 to store data. An optional access or control device 128 (e.g., a PN diode or field effect transistor (FET) wired as a diode, or some other element with a non-linear voltage-current response) may be coupled in series with the memristor 126 to prevent cross-talk during communication of neuronal spikes on adjacent axons or dendrites and to minimize leakage and power consumption. In some embodiments, a different memory element (e.g., static random access memory (SRAM), dynamic random access memory (DRAM), enhanced dynamic random access memory (EDRAM)) is used in lieu of the memristor 126.

FIG. 1E is a schematic diagram of an electronic neuron 130. Specifically, an electronic neuron 130 comprises electronic neuron spiking logic 131 and multiple resistor-capacitor (RC) circuits 132, 134. Although only two RC circuits are shown in the electronic neuron 130 of FIG. 1E, any suitable number of RC circuits may be used. Each RC circuit includes a resistor 136 and a capacitor 138 coupled as shown. When an electronic neuron fires (i.e., issues a spike) as a result of its membrane potential exceeding the neuron's firing threshold, the neuron maintains pre-synaptic and post-synaptic STDP variables. Each of these variables is a signal that decays with a relatively long time constant that is determined based on the values of the capacitor in a different one of the RCs 132, 134. Each of these signals may be sampled by determining the voltage across a corresponding RC circuit capacitor using, e.g., a current mirror. By sampling each of the variables, the length of time between the arrival of a pre-synaptic spike and a post-synaptic action potential following the spike arrival can be determined, as can the length of time between a post-synaptic action potential and a pre-synaptic spike arrival following the action potential. As explained above, the lengths of these times are used in STDP—that is, to effect synaptic potentiation and depression by adjusting synaptic weights, and thus to facilitate neurosynaptic learning.

FIG. 1F is a block diagram of the electronic neuron spiking logic 131 of FIG. 1E. The logic 131 includes three conceptual components: a synaptic component 140, a neuronal core component 142, and a comparator component 144. Although FIG. 1F shows only one synaptic component 140, in practice, a separate synaptic component 140 is used for each synapse from which the electronic neuron receives input. Thus, in some embodiments the electronic neuron contains multiple synaptic components 140, one for each synapse from which that neuron receives input. In other embodiments, the synaptic component 140 forms a part of the synapse itself and not the electronic neuron. In either type of embodiment, the end result is the same.

Each synaptic component 140 includes an excitatory/inhibitory signal generator 146, a weight signal generator 148 associated with the corresponding synapse, and a pulse generator 150. The pulse generator 150 receives a clock signal 152 and a spike input signal 154, as well as a weight signal 151 from the weight signal generator 148. The pulse generator 150 uses its inputs to generate a weighted spike signal 158—for instance, the spike input signal 154 multiplied by the weight signal 151. The width of the weighted spike signal pulse reflects the magnitude of the weighted signal, and thus the magnitude that will contribute to or take away from the membrane potential of the electronic neuron. The weighted signal for the synapse corresponding to the synaptic component 140 is provided to the core component 142, and similar weighted signals are provided from synaptic components 140 corresponding to other synapses from which the electronic neuron receives input. For each weighted signal that the core 142 receives from a synaptic component 140, the core 142 also receives a signal 156 from the excitatory/inhibitory signal generator 146 indicating whether the weighted signal 158 is an excitatory (positive) or inhibitory (negative) signal. An excitatory signal pushes the membrane potential of the electronic neuron toward its action potential threshold, while an inhibitory signal pulls the membrane potential away from the threshold. As explained, the neurosynaptic learning process involves the adjustment of synaptic weights. Such weights can be adjusted by modifying the weight signal generator 148.

The core component 142 includes a membrane potential counter 160 and a leak-period counter 162. The membrane potential counter receives the weighted signal 158 and the excitatory/inhibitory signal 156, as well as the clock 152 and a leak signal 164 from the leak-period counter 162. The leak-period counter 162, in turn, receives only clock 152 as an input.

In operation, the membrane potential counter 160 maintains a counter—initially set to zero that is incremented when excitatory, weighted signals 158 are received from the synaptic component 140 and that is decremented when inhibitory, weighted signals 158 are received from the synaptic component 140. When no synapse pulse is applied to the core component 142, the leak period counter signal 164 causes the membrane potential counter 160 to gradually decrement at a predetermined, suitable rate. This action mimics the leak experienced in biological neurons during a period in which no excitatory or inhibitory signals are received by the neuron. The membrane potential counter 160 outputs a membrane potential signal 166 that reflects the present value of the counter 160. This membrane potential signal 166 is provided to the comparator component 144.

The comparator component 144 includes a threshold signal generator 168 and a comparator 170. The threshold generator 168 generates a threshold signal 169, which reflects the threshold at which the electronic neuron 130 generates a spike signal. The comparator 170 receives this threshold signal 169, along with the membrane potential signal 166 and the clock 152. If the membrane potential signal 166 reflects a counter value that is equal to or greater than the threshold signal 169, the comparator 170 generates a spike signal 172, which is subsequently output via an axon of the electronic neuron. As numeral 174 indicates, the spike signal is also provided to the membrane potential counter 160, which, upon receiving the spike signal, resets itself to zero.

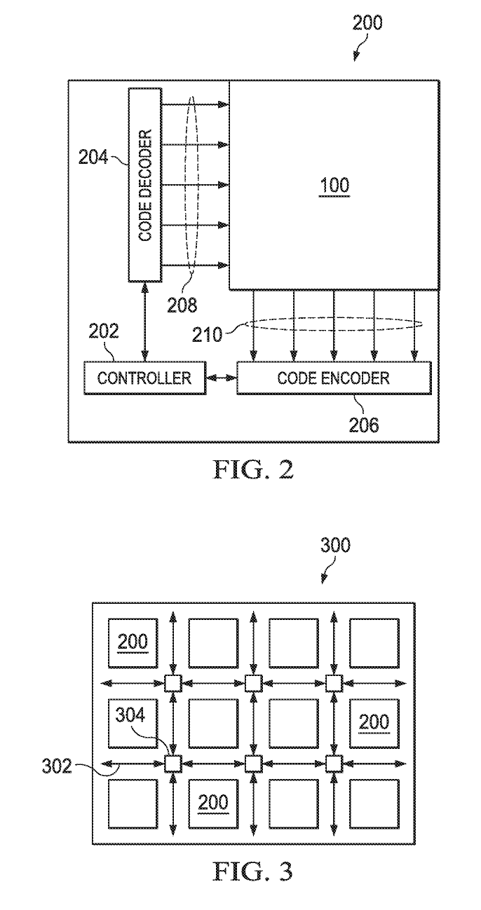

FIG. 2 is a schematic diagram of a neurosynaptic core 200 for use in a cognitive computer. The core 200 includes a neurosynaptic tile 100, a controller 202, a decoder 204, an encoder 206, inputs 208, and outputs 210. Spike events generated by electronic neurons generally take the form of data packets. These packets, which may be received from neurons on other cores external to the core 200, are decoded by the decoder 204 (e.g., to interpret and remove packet headers) and passed as inputs 208 to the neurosynaptic tile 100. Similarly, packets generated by neurons within the neurosynaptic tile 100 that are destined for neurons outside the core 200 are passed as outputs 210 to the encoder 206 for encoding (e.g., to include a header with a destination address). The controller 202 controls the decoder 204 and encoder 206.

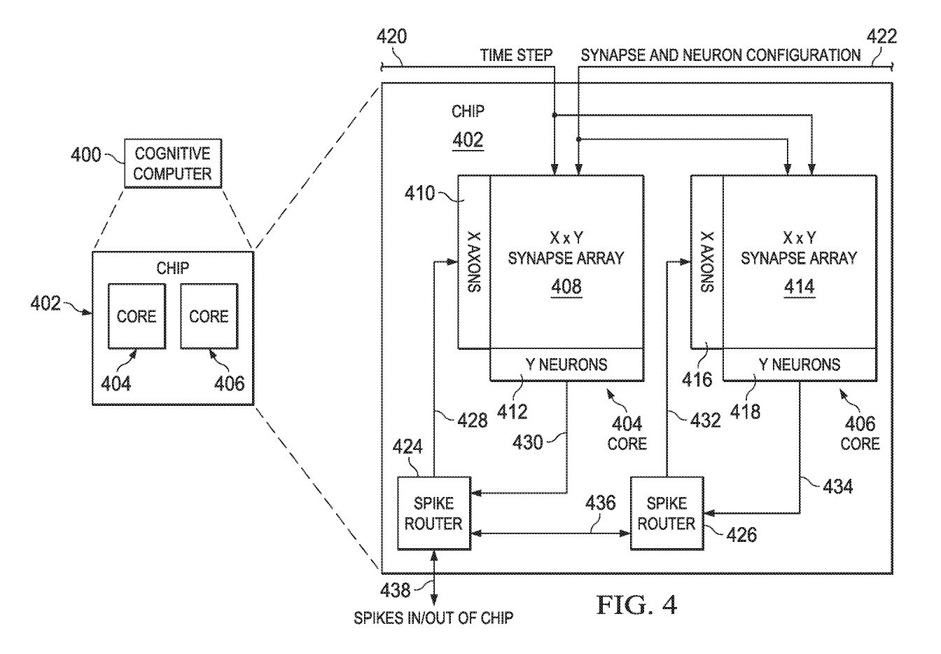

FIG. 3 is a schematic diagram of a multi-core neurosynaptic chip 300 for use in a cognitive computer. The chip 300 includes a plurality of neurosynaptic cores 200, such as the core 200 described with respect to FIG. 2. The cores 200 couple to each other via electrical connections (e.g., conductive traces). The chip 300 may include any suitable number of cores—for example, 4,096 or more cores on a single chip, with each core containing millions of electronic synapses. The chip 300 also contains a plurality of intrachip spike routers 304 that couple to a routing fabric 302. The cores 200 communicate with each other via the routers 304 and the fabric 302, using the aforementioned encapsulated, encoded packets to facilitate routing between cores and specific neurons within the cores.

FIG. 4 is a detailed schematic diagram of a dual-core neurosynaptic chip 402 for use in a cognitive computer 400. Specifically, a cognitive computer may include any suitable number of neurosynaptic chips 402, and each of these neurosynaptic chips 402 may include any suitable number of neurosynaptic cores, as previously explained. In the example of FIG. 4, the neurosynaptic chip 402 is a dual-core chip containing neurosynaptic cores 404, 406. The core 404 includes a synapse array 408 that includes a plurality of synapses that couple various axons 410 to dendrites. In some embodiments, axons 410 receive spikes from neurons directly coupled to the axons 410 and included on the core 404 (not specifically shown in FIG. 4, but an illustrative embodiment is shown in FIG. 1). In other embodiments, axons 410 are extensions of neurons located off of the core 404 (e.g., elsewhere on the chip 402, or on a different chip). In embodiments where the axons 410 couple directly to on-core neurons (e.g., as shown in FIG. 1), the spike router 424 provides spikes directly to the neurons' dendrites. In embodiments where the axons 410 are extensions of off-core neurons, the spike router 424 provides spikes from those neurons to the axons 410. Although a multitude of variations of such embodiments are possible, for brevity, FIG. 4 shows only an array of axons 410.

The synapse array 408 also couples to neurons 412. The neurons 412 may be a single-row, multiple-column array of neurons, or, alternatively, the neurons 412 may be a multiple-row, multiple-column array of neurons. In either case, dendrites of the neurons 412 couple to axons 410 in the synapse array 408, thus facilitating the transfer of spikes from the axons 410 to the neurons 412 via dendrites in the synapse array 408. The spike router 424 receives spikes from off-core sources, such as the core 406 or off-chip neurons. The spike router 424 uses spike packet headers to route the spikes to the appropriate neurons 412 (or, in some embodiments, on-core neurons directly coupled to axons 410). In either case, bus 428 provides data communication between the spike router 424 and the core 404. Similarly, neurons 412 output spikes on their axons and bus 430 provides the spikes to the spike router 424. The core 406 is similar or identical to the core 404. Specifically, the core 406 contains axons 416, neurons 418, and a synapse array 414. The axons 416 couple to a spike router 426 via bus 432, and neurons 418 couple to the spike router 426 via bus 434. The functionality of the core 406 is similar or identical to that of the core 404 and thus is not described. A bus 436 couples the spike routers 424, 426 to facilitate spike routing between the cores 404, 406. A bus 438 facilitates the communication of spikes on and off of the chip 402. The architectures shown in FIGS. 1-4 (e.g., the TRUENORTH® architecture by IBM®) are non-limiting; other architectural configurations are contemplated and included within the scope of the disclosure.

Various types of software may be written for use in cognitive computers. One programming methodology is described below, but the scope of disclosure is not limited to this particular methodology. Any suitable, known software architecture for programming neurosynaptic processing logic is contemplated and intended to fall within the scope of the disclosure. The software architecture described herein entails the creation and use of programs that are complete specifications of networks of neurosynaptic cores, along with their external inputs and outputs. As the number of cores grows, creating a program that completely specifies the network of electronic neurons, axons, dendrites, synapses, spike routers, buses, etc. becomes increasingly difficult. Accordingly, a modular approach may be used, in which a network of cores and/or neurons encapsulates multiple sub-networks of cores and/or neurons; each of the sub-networks encapsulates additional sub-networks of cores and/or neurons, and so forth. In some embodiments, the CORELET® programming language, library and development environment by IBM® may be used to develop such modular programs.

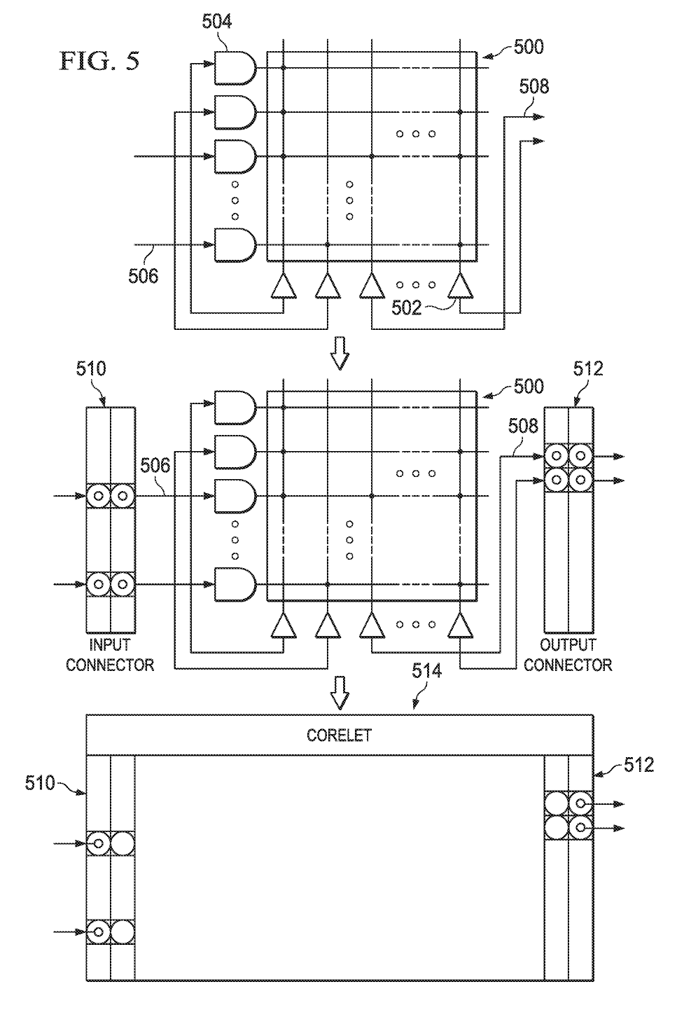

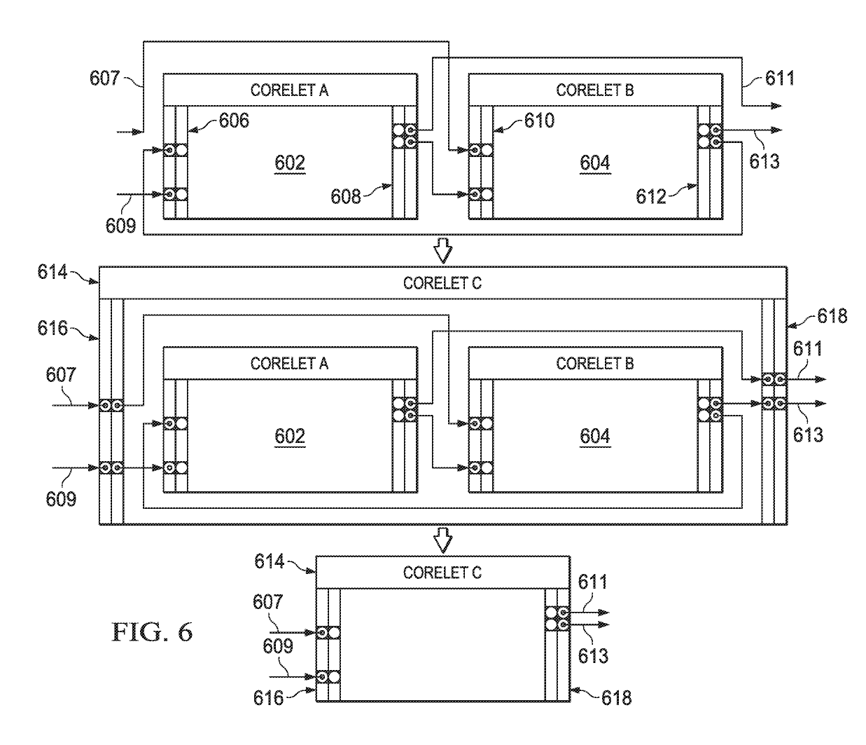

FIGS. 5 and 6 are conceptual diagrams illustrating the modular nature of the CORELET® programming architecture. FIG. 5 contains three panels. The first panel illustrates a neurosynaptic tile 500 containing a plurality of neurons 502 and axons 504, similar to the neurosynaptic architecture shown in FIG. 4. As shown, some of the neurons' outputs couple to the axons' inputs. However, inputs to other axons 504 are received from outside the tile 500, as numeral 506 indicates. Similarly, outputs from other neurons 502 are provided outside of the tile 500, as numeral 508 indicates. The second panel in FIG. 5 illustrates the initial step in the encapsulation of a tile into a corelet—that is, an abstraction that represents a program (for a neurosynaptic processing logic) that only exposes external inputs and outputs while encapsulating all other details into a “black box.” Thus, as shown in the second panel, the only inputs to the tile 500 are inputs 506 to some of the axons 504, and the only outputs from the tile 500 are outputs 508 from some of the neurons 502. The inputs 506 couple to an input connector 510, and the outputs couple to an output connector 512. The third panel in

FIG. 5 shows the completed corelet 514, with only the input connector 510 and output connector 512 being exposed, and with the remainder of the tile 500 having been encapsulated into the corelet 514. The completed corelet 514 constitutes a single building block of the CORELET® modular architecture; the corelet 514 may be grouped with one or more other corelets to form a larger corelet; in turn, that larger corelet may be grouped with one or more other larger corelets to form an even larger corelet, and so forth.

FIG. 6 includes three panels illustrating such encapsulation of multiple sub-corelets into a larger corelet. Specifically, the first panel includes corelets 602 and 604. Corelet 602 includes an input connector 606 and output connector 608. The remainder of the contents of the corelet 602 do not couple to circuitry outside of the corelet 602 and thus are not specifically shown as being coupled to the input connector 606 or the output connector 608. Similarly, corelet 604 includes an input connector 610 and an output connector 612. Certain inputs to and outputs from the corelets 602, 604 couple to each other, while other such inputs and outputs do not (i.e., inputs 607, 609 are not received from either corelet 602, 604, and outputs 611, 613 are not provided to either corelet 602 or 604). Thus, as shown in the second and third panels of

FIG. 6, when the corelets 602, 604 are grouped into a single, larger corelet 614, only inputs 607, 609 are exposed on the input connector 616, and only outputs 611, 613 are exposed on the output connector 618. The remaining contents of the corelet 614 are encapsulated. As explained, one purpose of encapsulating neurosynaptic processing logic into corelets and sub-corelets is to organize the processing logic in a modular way that facilitates the creation of CORELET® programs, since such programs are complete specifications of networks of neurosynaptic cores. Although FIGS. 5 and 6 demonstrate the modular nature of the CORELET® software architecture, the CORELET® syntax itself is known and is not described here. Cognitive computing software systems other than CORELET® also may be used in conjunction with the hardware described herein or with any other suitable cognitive computing hardware. All such variations and combinations of potentially applicable cognitive computing hardware and software are contemplated and may be used to implement the oilfield operations enhancement techniques described herein.

The remainder of this disclosure describes the use of hardware and software cognitive computing technology to facilitate meetings. As explained above, any suitable cognitive computing hardware or software technology may be used to implement such techniques. This cognitive computing technology may include none, some or all of the hardware and software architectures described above. For example, the meeting facilitation techniques described below may be implemented using the CORELET® programming language or any other software language used in conjunctive with cognitive computers. The foregoing architectural descriptions, however, are non-limiting. Other hardware and software architectures may be used in lieu of, or to complement, any of the foregoing technologies. Any and all such variations are included within the scope of the disclosure.

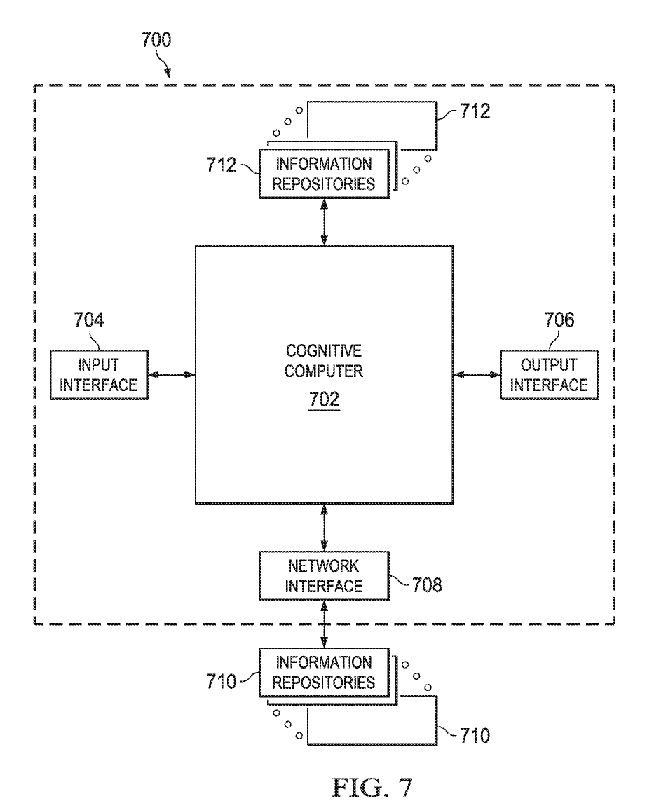

FIG. 7 is a block diagram of a cognitive computing system 700 that has access to multiple information repositories. Specifically, the cognitive computing system 700 includes a cognitive computer 702 (i.e., any suitable computer that includes neurosynaptic processing logic and cognitive algorithm-based software, such as those described above) coupled to an input interface 704, an output interface 706, a network interface 708 and one or more local information repositories 712. In at least some embodiments, the input interface 704 is any suitable input device(s), such as a keyboard, mouse, touch screen, microphone, video camera, or one or more wearable devices (e.g., augmented reality device such as GOOGLE GLASS®). Other input devices are contemplated. The output interface 706 may include one or more of a display and an audio output device. Other output devices are contemplated. The network interface 708 is, for example, a network adapter or other suitable interface logic that enables communication between the cognitive computer 702 and any device not directly coupled to the cognitive computer 702. The local information repositories 712 include, without limitation, thumb drives, compact discs, Bluetooth devices, and any other device that can couple directly to the cognitive computer 702 such as by universal serial bus (USB) cable or high definition multimedia interface (HDMI) cable.

The cognitive computer 702 communicates with any number of remote information repositories 710 via the network interface 708. The quantity and types of such information repositories 710 may vary widely, and may include, without limitation, other cognitive computers; databases; distributed databases; sources that provide real-time data pertaining to oil and gas operations, such as drilling, fracturing, cementing, or seismic operations; servers; other personal computers; mobile phones and smart phones; websites and generally any resource(s) available via the Internet, World Wide Web, or a local network connection such as a virtual private network (VPN); cloud-based storage; libraries; and company-specific, proprietary, or confidential data. Any other suitable source of information with which the cognitive computer 702 can communicate is included within the scope of disclosure as a potential information repository 710. The cognitive computer 702—which, as described above, has the ability to learn, process imprecise or vague information, and adapt to unfamiliar environments—is able to receive an oilfield operations indication (e.g., via one or more input interfaces 704) and intelligently determine one or more recommendations based on the oilfield operations indication and associated information; prior learned knowledge and training; scenarios generated using oilfield operations models; and resources accessed from information repositories. The software stored on the cognitive computer 702 is probabilistic (i.e., non-deterministic) in nature, meaning that its behavior is guided by probabilistic determinations regarding the various possible outcomes of each oilfield operations model scenario and each recommendation available in a given oilfield operations indication.

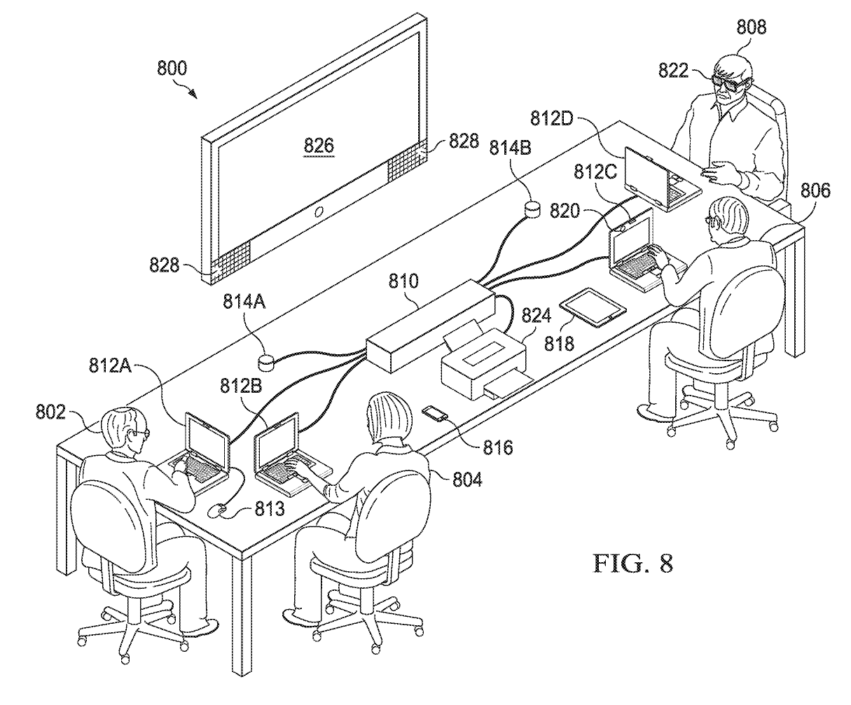

FIG. 8 is an illustration of an exemplary meeting environment 800 with multiple human participants 802, 804, 806, 808 and a cognitive computing participant 810 of the type described in detail above and with respect to FIGS. 1A-7. In some embodiments, multiple cognitive computing participants 810 may participate in a meeting, and in such embodiments, the cognitive computing participants 810 are able to communicate with each other as well as with the human participants. The meeting environment 800 may be a physical meeting room, for instance, on the campus of an oil and gas firm. The scope of disclosure, however, includes other types of meeting environments, including virtual meeting environments in which the participants are in various geographic locations (a subset of whom may be in the same room) and the meeting is conducted with the aid of a telephone, video conferencing equipment, or other such technologies. The remainder of this discussion generally assumes that the meeting environment 800 is a single physical meeting room, such as a conference room, but the discussion applies to virtual meeting environments as well.

In addition to the participants, the meeting environment 800 includes multiple input/output devices with which the participants may interact with each other, with the cognitive computing participant 810, and with other computers or servers with which the input devices can communicate. For example, the meeting environment 800 includes laptop computers 812A-812D—one for each human participant. Such computers facilitate communication between the participants, including the cognitive computing participant 810. For instance, input provided by one of the human participants 802, 804, 806, 808 may be sent directly to all participants, some participants, or just one participant (e.g., just the cognitive computing participant 810). Similarly, the cognitive computing participant 810 may provide output that is available on all, some, or just one of the laptop computers 812A-812D. The computers also facilitate communications with entities other than meeting participants—e.g., the Internet and World Wide Web, computers or non-participants located in various geographic areas, and other such entities.

The environment 800 also includes microphones 814A, 814B. In some cases, such as in the environment 800, a single microphone may be shared by multiple participants, and in other cases, each participant may have his or her own microphone. In some cases, a microphone may be positioned in the environment 800 so that it receives speech output by the cognitive computing participant 810. The cognitive computing participant 810 may use the microphones 814A, 814B to record some or all of the meeting. Alternatively or in addition, the microphones 814A, 814B may be used to teleconference with one or more participants who are not present in the conference room depicted in meeting environment 800.

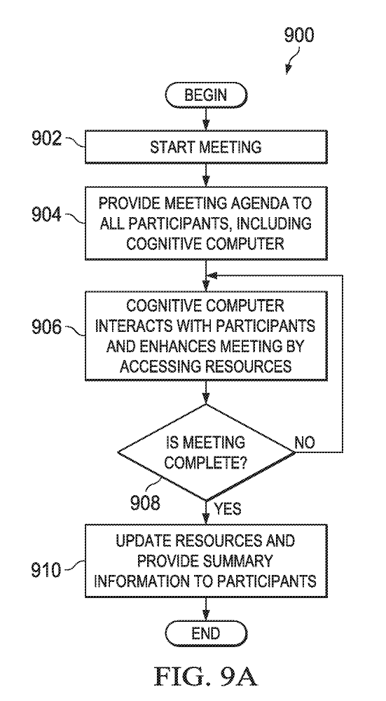

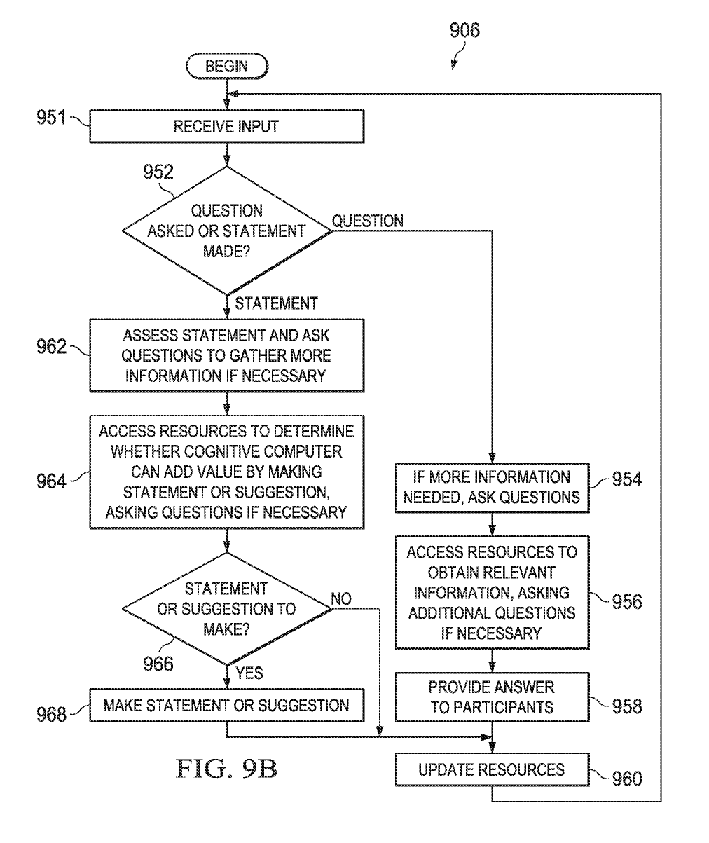

The meeting environment 800 may include other types of input and output devices. For example, the environment 800 may include one or more smart phones 816; one or more touch screen tablets 818; one or more cameras 820; one or more wearable devices 822 (e.g., augmented reality devices such as GOOGLE GLASS®); one or more printers 824; one or more displays 826; and one or more speakers 828. With the exception of the printer 824, display 826, and speaker 828, each of these devices is able to capture various types of input and provide that input to one or more entities, including all, some, one or none of the participants, as described above with respect to the laptop computers 812A-812D. In addition, the camera 820 may be used to capture information and provide it to one or more participants or entities. For example, multiple cameras 802 may be used to identify the human participants attending the meeting by comparing an image of each participant captured by the cameras 802 and comparing those images to images stored in a database. In another example, a camera 820 may capture the facial expressions of a human participant and provide the images to the cognitive computing participant 810, which, in turn, is trained to interpret the facial expression images to determine the emotions of the human participant (e.g., with the assistance of commercially available facial recognition software). The cognitive computing participant 810 may determine, for instance, that the facial expressions of the human participant indicate confusion regarding a topic being discussed, and the cognitive computing participant 810 may offer that human participant additional assistance. The display 826 may couple to any electronic device in or outside of the meeting environment 800, including the cognitive computing participant 810, thus enabling various entities to display presentations, photos, videos and the like on the display 826. The speakers 828 output sound produced by, e.g., one or more of the participants (whether located in the meeting room or in a separate geographic area). The scope of disclosure is not limited to the specific input/output devices depicted in FIG. 8 and expressly described herein. Any and all types of input/output devices may be used in the meeting environment 800. An illustrative meeting in the context of the meeting environment 800 is now described with respect to FIGS. 9A and 9B.

FIG. 9A is a flow diagram of an illustrative method 900 used to facilitate meetings using cognitive computers—for example, in the meeting environment 800. The meeting begins at step 902, in which the various participants are assembled in a single meeting room, in a virtual meeting using teleconferencing technology, videoconferencing technology, or other online meeting platforms such as WEBEX®. Alternatively, the meeting may be some combination of the foregoing types of meetings. The meeting may address any topic—for example, in the oil and gas space, the meeting may be an initial brainstorming meeting, intellectual property meeting, planning meeting, presentation meeting, oil rig meeting and/or other operational meetings. Next, the meeting agenda is provided to all participants, including the human participants 802, 804, 806, 808 and the cognitive computing participant 810 (step 904). The meeting agenda may take the form of a written document (e.g., on paper or on a presentation slide), video (e.g., displayed on display 826), or audio (e.g., a cognitive computing participant that knows the meeting agenda may describe the agenda via the speakers 828; one of the human participants 802, 804, 806, 808 may orally describe the agenda). Other communication modalities for presenting the meeting agenda to the participants are contemplated and included within the scope of the disclosure. The cognitive computing participant 810 does not necessarily require receipt of a copy of a meeting agenda. In some cases, for instance, the cognitive computing participant 810 may not be provided an agenda, and in other cases, there may be no meeting agenda in written form. In such cases, the cognitive computing participant 810 observes the meeting and uses probabilistic analyses of its observations to determine the agenda topics being discussed. In some embodiments, the cognitive computing participant 810 may determine the entire meeting agenda at the beginning s of the meeting, but in more practical scenarios in which no written agenda is provided, the cognitive computing participant 810 may observe the proceedings for the duration of the meeting to continuously or occasionally determine the meeting agenda. Notwithstanding the foregoing and following description, step 904 is optional, and meetings may proceed without an agenda being described and without the cognitive computing participant identifying the agenda.

In some embodiments, the cognitive computing participant 810 is the leader of the meeting and, thus, it sets the agenda. For instance, the cognitive computing participant 810 may periodically and unilaterally review its resources and, during such review, it may determine that a meeting should be called to discuss a particular topic. In such cases, the cognitive computing participant 810 uses its resources to determine which human participants and cognitive computing participants to invite, and it sends them invitations (e.g., MICROSOFT OUTLOOK® calendar invitations) specifying the meeting date, time and location. The cognitive computing participant 810 may include additional, relevant information in the invitation (e.g., particular instructions for specific participants). In addition, the cognitive computing participant 810 may reserve meeting rooms using relevant corporate software. Once the meeting begins, the cognitive computing participant may begin the meeting with a background explanation of the reason for the meeting and any and all other information that may be useful to explain the purpose of the meeting. In doing so, it may produce a written agenda that it e-mails to the participants or displays on the display 826. During the course of the meeting, the cognitive computing participant 810 acts as a facilitator, ensuring that the meeting remains on track and does not stray to tangential topics, and further ensuring that all relevant laws and policies are complied with during the meeting (e.g., information technology policies, government regulations, intellectual property laws).

Once the agenda has been determined, the meeting progresses to discussion of the agenda topics (step 906). In step 906, the cognitive computing participant interacts with the other participants and enhances the meeting by combining access to a vast array of resources with its ability to think in a manner similar to the mammalian brain. This step 906 is now described with respect to the method 906 of FIG. 9B.

FIG. 9B is a flow diagram of another illustrative method 906 used to facilitate meetings using cognitive computers. Specifically, the method 906 describes various actions of the cognitive computing participant 810 during the meeting and, thus, is a detailed description of step 906 in FIG. 9A. The method 906 begins with the cognitive computing participant detecting input (step 951). Referring briefly to FIG. 8, such input may take the form of audio input that the cognitive computing participant receives through microphones 814A, 814B; visual input that the cognitive computing participant receives through a camera 820 or through one or more other cameras trained in various directions in the meeting room (e.g., to view a presentation on the display 826; to observe one or more human participants 802, 804, 806, 808; to scan documents via printer 824; to view documents or other materials distributed during the meeting); text (e.g., one or more human participants may communicate with the cognitive computing participant via email, instant messaging, or other software platform using laptop computers 812A-812D, mobile devices 816, or tablets 818); and/or wearable devices (e.g., to which a human participant may provide input via touch, oral instruction, or eye movement, such as GOOGLE GLASS®). Other input devices are contemplated and included within the scope of the disclosure. Referring again to FIG. 9B, the input received at step 951 may be, for instance, a question from one of the participants (human or machine) directed at the cognitive computing participant; a statement directed at the cognitive computing participant, a human participant, or both, and/or other suitable forms of input. In some cases, input provided to the cognitive computing participant 810 is private, meaning that a human participant sends a private e-mail, instant message or other communication directly to the participant 810 and the participant 810 responds privately. Other input is non-private; for example, it may be spoken by a human participant aloud within the meeting environment 800.

The method 906 proceeds with the cognitive computing participant determining whether the received input is a question or a statement (step 952). If the input is a question, the cognitive computing participant performs steps 954, 956, 958 and 960; otherwise, if the input is a statement, the cognitive computing participant performs steps 962, 964, 966, 968 and 960. Assuming that the input is a question, the method 906 comprises the cognitive computing participant asking one or more follow-up questions of the other participants (step 954). For example, if human participant 802 asks what fracturing plan the team agreed to at the previous meeting, the cognitive computing participant may ask human participant 802 to specify the well to which the human participant 802 is referring if the identity of the well is not apparent from the preceding conversation.

Still assuming that the input is a question, the cognitive computing participant then accesses one or more resources to obtain relevant information that assists the cognitive computer in answering the question, and it may ask additional questions of the other participants as necessary (step 956). As explained above, the resources to which the cognitive computing participant has access is vast and can include, without limitation, any material available via the Internet or World Wide Web; books; journals; patents; patent applications; white papers; newspapers; magazines and periodicals; proprietary data and local data (e.g., coupled to the cognitive computing participant via a universal serial bus port; accessible on a company intranet) that form a knowledge corpus; other machines (both von Neumann and cognitive-based) with which the cognitive computing participant can interact; and virtually any other information in any form and in any language to which the cognitive computing participant may have access. Thus, for example, to answer the question regarding what fracturing plan the team agreed to at the previous meeting or what suggestions were made, the cognitive computing participant may access minutes or reports that it generated at the previous meeting. The method 906 then comprises the cognitive computing participant answering the human participant 802 accordingly (step 958) and updating the resources to which it has access based on the interaction (e.g., updating meeting minutes to reflect the question and answer) (step 960). The scope of disclosure is not limited to such simple tasks, however. On the contrary, as explained above, the cognitive computing participant uses a neurosynaptic architecture to execute cognitive, probabilistic algorithms that enable it to use relevant resources to perform complex probabilistic or deterministic data analyses, run simulations and oilfield operations models, and other such multifaceted operations—essentially, any and all actions that it has been trained to perform or that it can unilaterally learn to perform using the resources to which it has access.

If, however, the cognitive computing participant determines at step 952 that a statement was made, the method 906 comprises the cognitive computing participant assessing the statement and asking questions to gather more information, if necessary (step 962). The method 906 next includes the cognitive computing participant accessing its resources to determine whether it can add value by making a statement or suggestion (step 964). The cognitive computing participant may also ask additional questions as it accesses the resources, as necessary. For instance, during a discussion about a novel technology that the human participants have invented, the human participant 804 may tell the human participant 808 that she thinks their technology has already been patented in the United States by a particular company. The cognitive computing participant hears this discussion and determines that it can add value to the discussion by accessing its resources to verify the statement made by human participant 804. Thus, the cognitive computing participant proactively accesses the patent databases of various countries, generates search terms appropriate for the technology being discussed, and enters the search terms into the patent databases in an attempt to identify the most relevant patents and patent applications. The cognitive computing participant may find five relevant patents and may display a ranked list of the patents, with the top-ranked patent being the patent that human participant 804 was referencing. The cognitive computing participant also may summarize each of the five patents, explain its opinion on whether the patents disclose the technology being discussed and to what degree, and offer suggestions on how to proceed (e.g., by describing the ways in which the participants' invention and the five patents differ). When it provides suggestions, the cognitive computing participant may provide arguments supporting and opposing each suggestion, thus enabling the human participants to make better-informed decisions and facilitating conversation between the human participants and the cognitive computing participant. The cognitive computing participant may provide all such information in the form of an e-mail, voice, a presentation, some other communication technique, or a combination thereof. Based on these results, the human participants may decide that their invention has not been patented and they may choose to move forward with filing one or more patent applications describing the invention. As explained above in detail, the cognitive computing participant performs these actions by executing its cognitive, probabilistic algorithms.

The method 906 subsequently includes the cognitive computing participant determining whether it has a statement or suggestion to make to the rest of the participants in the meeting (step 966). If so, it makes the statement or suggestion (step 968), for example, by voice, email, audio, video, images, etc. In either case, the cognitive computing participant updates one or more resources based on these interactions (step 960), and control of the method 906 again returns to step 951.

As previously explained, FIG. 9B describes the performance of step 906, which is found in the method 900 of FIG. 9A. Thus, referring again to FIG. 9A, the method 900 further includes the cognitive computing participant determining whether the meeting is complete (step 908). In cases where the cognitive computer participant is running the meeting, it may unilaterally end the meeting. Alternatively, it may end the meeting at a scheduled time, upon suggestion by another participant, or upon detecting several lulls in the conversation. Alternatively, another participant may unilaterally end the meeting. If the meeting is not complete, control of the method 900 returns to step 906. Otherwise, if the method 900 is complete, the cognitive computing participant executes any decisions that were made during the meeting, updates one or more resources based on the meeting and optionally provides a meeting summary record (e.g., minutes) of the meeting to one or more of the participants (step 910). Meeting summary records preferably are expansive in scope and may include some or even the entirety of the meeting. For example and without limitation, such a meeting summary record may include: digital copies of information presented during the meeting (e.g., slideshow presentations, reports, camera images of materials presented, a video recording of some or all of the meeting); an audio recording of some or all of the meeting; a transcript of the entire meeting in a format that the cognitive computing participant and other cognitive computers can search and that specifies all speakers and what they said; subjects discussed; links (e.g., hypertext transfer protocol links) to materials that were presented; keywords or phrases (e.g., terms used during a meeting beyond a predetermined number of times; product names; technologies; names of persons mentioned during the meeting); suggested resources associated with the meeting topic and conversation content; and security clearance requirements associated with the meeting summary record, where different requirements may be imposed for different parts of the meeting summary record. For instance, in some embodiments, some or all of the meeting summary record may be designated as “public” and thus accessible to all persons within an organization. In some embodiments, some or all of the meeting summary record may be designated as “restricted,” meaning that only a subset of persons within the organization may have access to the record. In some such embodiments, those without access to the record may be informed of the topic of the meeting and may be directed to the participants in the meeting for further information. In some embodiments, some or all of the meeting summary record may be designated as “hidden,” meaning that its contents—and even its existence—are hidden from some or all persons within the organization. Numerous other variations and modifications will become apparent to those skilled in the art once the above disclosure is fully appreciated. It is intended that the following claims be interpreted to embrace all such variations, modifications and equivalents. In addition, the term “or” should be interpreted in an inclusive sense.

At least some embodiments herein are directed to a system for facilitating meetings that comprises: neurosynaptic processing logic; and one or more information repositories accessible to the neurosynaptic processing logic, wherein, during a meeting of participants that includes the neurosynaptic processing logic, the neurosynaptic processing logic accesses resources from the one or more information repositories to perform a probabilistic analysis, and wherein, based on said probabilistic analysis, the neurosynaptic processing logic answers a question from one or more of the participants, asks a question of the participants, makes a statement to the participants, or provides a suggestion to the participants. Some or all such embodiments may be supplemented using one or more of the following concepts, in any order and in any combination: wherein the neurosynaptic processing logic accesses said resources based on input collected from one or more of the participants; wherein, without human assistance, the neurosynaptic processing logic generates an argument in favor of or opposing said suggestion; wherein the neurosynaptic processing logic generates a record of at least part of said meeting; wherein the record includes information selected from the group consisting of: names of the participants; input provided by each of said participants during the meeting; links to materials presented or distributed during the meeting; copies of materials presented or distributed during the meeting; keywords and phrases relating to said meeting; and security clearance requirements to access the record; wherein said accessed resources include documents identifying intellectual property rights, and wherein, based on said probabilistic analysis, the neurosynaptic processing logic provides to one or more of said participants a subset of said documents that the logic determines to be relevant to said meeting; wherein the neurosynaptic processing logic executes a decision that is made during the meeting; wherein said meeting participants include oil and gas industry personnel; wherein the participants are human participants, other cognitive computer participants, or a combination of human participants and cognitive computer participants; wherein the neurosynaptic processing logic interacts with one or more of the participants based on facial expressions of said one or more of the participants; wherein the neurosynaptic processing logic receives input from at least one of the participants via a wearable device.

At least some embodiments described herein are directed to a cognitive computer for facilitating meetings, comprising: a plurality of neurosynaptic cores operating in parallel, each neurosynaptic core coupled to at least one other neurosynaptic core and comprising multiple electronic neurons, electronic dendrites and electronic axons, at least some of said electronic dendrites and electronic axons coupling to each other in a synapse array; and a network interface coupled to at least one of the plurality of neurosynaptic cores, the network interface provides access to resources in one or more information repositories, wherein the plurality of neurosynaptic cores accesses said resources via the network interface to interact with one or more participants in a meeting. Some or all such embodiments may be supplemented using one or more of the following concepts, in any order and in any combination: wherein said meeting occurs at least partially online; wherein, to interact with said one or more participants, the plurality of neurosynaptic cores answers a question from one or more of the participants, asks a question of the participants, makes a statement to the participants, or provides a suggestion to the participants; wherein said question is regarding a prior decision made by at least one of said one or more participants or a prior suggestion made by at least one of said one or more participants, said prior decision and said prior suggestion made during said meeting or during a different meeting; wherein said participants include human participants, cognitive computer participants, or both; wherein the plurality of neurosynaptic cores generates a record of at least part of said meeting; wherein the meeting is between oil and gas industry personnel.

At least some embodiments are directed to a method for facilitating meetings, comprising: conducting a meeting between one or more human participants and a cognitive computer that includes a plurality of neurosynaptic cores; the cognitive computer observing interactions between the one or more human participants; the cognitive computer accessing resources from one or more information repositories to perform a probabilistic analysis based on said observation; and the cognitive computer using the probabilistic analysis to make a statement, offer a suggestion, ask a question, or answer a question during the meeting. Some or all such embodiments may be supplemented using the following concept: wherein observing interactions includes one or more actions selected from the group consisting of: listening to said interactions using a microphone; watching a presentation using a camera; reading a report using the camera; observing a facial expression using the camera; receiving input from a keyboard; receiving input from a touch screen; receiving input from a mouse or touchpad; and receiving input from a wearable device.

The following is claimed:

1. A system for facilitating meetings, comprising:
neurosynaptic processing logic; and
one or more information repositories accessible to the neurosynaptic processing logic,
wherein, during a meeting of participants that includes the neurosynaptic processing logic, the neurosynaptic processing logic accesses resources from the one or more information repositories to perform a probabilistic analysis, and
wherein, based on said probabilistic analysis, the neurosynaptic processing logic answers a question from one or more of the participants, asks a question of the participants, makes a statement to the participants, or provides a suggestion to the participants.

2. The system of claim 1, wherein the neurosynaptic processing logic accesses said resources based on input collected from one or more of the participants.

3. The system of claim 1, wherein, without human assistance, the neurosynaptic processing logic generates an argument in favor of or opposing said suggestion.

4. The system of claim 1, wherein the neurosynaptic processing logic generates a record of at least part of said meeting.

5. The system of claim 4, wherein the record includes information selected from the group consisting of: names of the participants; input provided by each of said participants during the meeting; links to materials presented or distributed during the meeting; copies of materials presented or distributed during the meeting; keywords and phrases relating to said meeting; and security clearance requirements to access the record.

6. The system of claim 1, wherein said accessed resources include documents identifying intellectual property rights, and wherein, based on said probabilistic analysis, the neurosynaptic processing logic provides to one or more of said participants a subset of said documents that the logic determines to be relevant to said meeting.

7. The system of claim 1, wherein the neurosynaptic processing logic executes a decision that is made during the meeting.

8. The system of claim 1, wherein said meeting participants include oil and gas industry personnel.

9. The system of claim 1, wherein the participants are human participants, other cognitive computer participants, or a combination of human participants and cognitive computer participants.

10. The system of claim 1, wherein the neurosynaptic processing logic interacts with one or more of the participants based on facial expressions of said one or more of the participants.

11. The system of claim 1, wherein the neurosynaptic processing logic receives input from at least one of the participants via a wearable device.

12. A cognitive computer for facilitating meetings, comprising:
a plurality of neurosynaptic cores operating in parallel, each neurosynaptic core coupled to at least one other neurosynaptic core and comprising multiple electronic neurons, electronic dendrites and electronic axons, at least some of said electronic dendrites and electronic axons coupling to each other in a synapse array; and
a network interface coupled to at least one of the plurality of neurosynaptic cores, the network interface provides access to resources in one or more information repositories,
wherein the plurality of neurosynaptic cores accesses said resources via the network interface to interact with one or more participants in a meeting.

13. The computer of claim 12, wherein said meeting occurs at least partially online.

14. The computer of claim 12, wherein, to interact with said one or more participants, the plurality of neurosynaptic cores answers a question from one or more of the participants, asks a question of the participants, makes a statement to the participants, or provides a suggestion to the participants.

15. The computer of claim 14, wherein said question is regarding a prior decision made by at least one of said one or more participants or a prior suggestion made by at least one of said one or more participants, said prior decision and said prior suggestion made during said meeting or during a different meeting.

16. The computer of claim 12, wherein said participants include human participants, cognitive computer participants, or both.

17. The computer of claim 12, wherein the plurality of neurosynaptic cores generates a record of at least part of said meeting.

18. The computer of claim 12, wherein the meeting is between oil and gas industry personnel.

19. A method for facilitating meetings, comprising:
conducting a meeting between one or more human participants and a cognitive computer that includes a plurality of neurosynaptic cores;
the cognitive computer observing interactions between the one or more human participants;
the cognitive computer accessing resources from one or more information repositories to perform a probabilistic analysis based on said observation; and
the cognitive computer using the probabilistic analysis to make a statement, offer a suggestion, ask a question, or answer a question during the meeting.

20. The method of claim 19, wherein observing interactions includes one or more actions selected from the group consisting of: listening to said interactions using a microphone; watching a presentation using a camera; reading a report using the camera; observing a facial expression using the camera; receiving input from a keyboard; receiving input from a touch screen; receiving input from a mouse or touchpad; and receiving input from a wearable device.
